(19) United States
(12) Patent Application Publication
(10) Pub. No.: US 2024/0365458 A1
(43) Pub. Date: Oct. 31, 2024

(54) LED LAMP SYSTEM AND CONTROL METHOD THEREOF

(71) Applicant: HYUNDAI MOBIS CO., LTD., Seoul (KR)

(72) Inventor: Myeong Je KIM, Seoul (KR)

(73) Assignee: HYUNDAI MOBIS CO., LTD., Seoul (KR)

(21) Appl. No.: 18/399,133

(22) Filed: Dec. 28, 2023

(30) Foreign Application Priority Data
Apr. 28, 2023 (KR) 10-2023-0056564

(51) Int. Cl. H05B 47/185; G09G 5/00; H05B 45/30

(52) U.S. Cl. CPC H05B 47/185; G09G 5/006; H05B 45/30; G09G 2350/00; G09G 2370/10

(57) ABSTRACT

Provided are a lamp system and a control method thereof, and more particularly, a lamp system having a reduced material cost and improved assembly by transmitting a direct current (DC) control signal, which is to be transmitted to a power supply unit, also to a communication line for transmitting an image signal from an integrated control unit, and a control method thereof.

### CROSS-REFERENCE TO RELATED APPLICATIONS

This application claims priority under 35 U.S.C. § 119 to Korean Patent Application No. 10-2023-0056564, filed on Apr. 28, 2023, in the Korean Intellectual Property Office, the disclosure of which is incorporated herein by reference in its entirety.

### TECHNICAL FIELD

The following disclosure relates to a lamp system and a control method thereof, and more particularly, to a lamp system having a reduced material cost and improved assembly by transmitting a direct current (DC) control signal, which is to be transmitted to a power supply unit, also to a communication line for transmitting an image signal from an integrated control unit, and a control method thereof.

### BACKGROUND

A headlamp of a vehicle may serve an important function in both the function and design of the vehicle. The headlamp may provide functions to ensure a vehicle driver's visibility at night, and notify another vehicle or a pedestrian of the presence of the vehicle. The headlamp may occupy such a large portion of a design element of the vehicle to be referred to as a vehicle eye. The headlamp may be a major part that is changed even in a facelift model or the like.

Before the 1970s, an incandescent bulb referred to as a filament was used for the headlamp. However, the incandescent bulb had a limitation as the headlamp due to its short lifespan and low brightness. A halogen lamp developed after the incandescent bulb had an advantage of a wide angle of light diffusion, easy visibility, and a small size. Afterwards, a light emitting diode (LED) lamp recently introduced after a high intensity discharge (HID) lamp is rapidly emerging as the headlamp.

In recent years, the vehicle headlamp has been provided not only to provide light emission to secure the driver's forward visibility, but also to perform an entertainment function or a communication function by outputting various image signals.

The LED lamp performing these various functions may include an integrated control unit integrating and controlling driving of the lamp and image signal transmission, a power supply unit supplying power to the LED lamp, and an optical output unit outputting an image signal received from the integrated control unit through a plurality of LED light source units.

Here, the integrated control unit may transmit a direct current (DC) control signal to control power supply to the power supply unit, transmit the image signal and a communication control signal to the optical output unit, and thus require two communication lines to transmit the signals.

However, these two communication lines may be a factor in increasing difficulty of assembling the lamp and increasing a material cost. Therefore, there is a need for an improved lamp system including one integrated communication line.

### SUMMARY

An embodiment of the present disclosure is directed to providing a lamp system having a reduced material cost and improved assembly by transmitting a direct current (DC) control signal, which is to be transmitted to a power supply unit, also to a communication line for transmitting an image signal from an integrated control unit, and a control method thereof.

The present disclosure may have the following features to solve the above problem.

In one general aspect, provided is a lamp system including: an optical output unit outputting light; a power supply unit supplying power to the optical output unit; and an integrated control unit connected to the optical output unit to transmit a first signal including an image signal to be output from the optical output unit and a second signal including a direct current (DC) control signal for controlling the power supply unit together, wherein the integrated control unit includes a first communication unit connected to enable its communication with the optical output unit, a graphics processing unit generating the first signal to be transmitted to the optical output unit and transmitting the generated first signal to the first communication unit, and a controller controlling the graphics processing unit and the power supply unit, and controlling the power supply unit by transmitting the second signal for controlling the power supply unit to the first communication unit.

The optical output unit may include a light source unit outputting light, a light source drive unit driving the light source unit based on the received first signal, and a second communication unit communicating with the first communication unit to transmit the first signal to the light source drive unit and transmit the second signal to the power supply unit.

The first communication unit and the second communication unit may be connected to each other through a coaxial line.

The first communication unit may include a serializer converting the first signal transmitted from the graphics processing unit into serial data and transmitting the serial data, and a signal transmission circuit transmitting the second signal generated by the controller to the second communication unit, and the second communication unit may include a de-serializer de-serializing the serial data received from the first communication unit to the first signal, and a signal reception circuit receiving the second signal of the first communication unit and transmitting the received second signal to the power supply unit.

The serializer may include an encoder converting the first signal transmitted from the graphics processing unit into the serial data, the de-serializer may include a decoder de-serializing the serial data transmitted from the serializer through the coaxial line, and the first signal may include the image signal in a high frequency band and a communication control signal in a low frequency band.

The signal transmission circuit may include R1 having one end connected to the controller and the other end connected to one end of the coaxial line, and C1 having one end connected to the serializer and the other end connected to the one end of the coaxial line, the signal reception circuit may include C2 having one end connected to the other end of the coaxial line and the other end connected to the de-serializer, R2 having one end connected to the other end of the coaxial line, and R3 having one end connected to the other end of R2 and the other end grounded, and R2 may have the other end connected to the power supply unit to transmit the second signal to the power supply unit.

The signal transmission circuit may further include C3 having one end connected to the controller and the other end grounded to remove an alternating current (AC) noise from the second signal, the signal reception circuit may further include C4 having one end connected to the other end of R2 and the other end grounded to be connected in parallel with R3 and remove the AC noise from the received second signal, and C1>C3, C2>C4, and C3<C4.

The coaxial line may have a predetermined impedance to increase transmission efficiency of the first signal, and the predetermined impedance may be 50Ω.

Both the ends of R1 to R3 and C1 to C4 may be connected to the coaxial line through a component pad, and the component pad and the coaxial line may be stacked on a ground plate, an auxiliary layer may be further provided between the component pad or the coaxial line and the ground plate, and the auxiliary layer below the component pad may be cut off when the horizontal or vertical length of the component pad is greater than a width of the coaxial line based on a horizontal cross section of the component pad bonded to the R1 to R3 and the C1 to C4, and a cut-off region may have a size of 1.3 to 1.4 times the horizontal or vertical length of the component pad.

In another general aspect, provided is a control method of a lamp system, the method including: a) activating, by a power supply unit, a light source drive unit and a de-serializer by supplying power thereto as an integrated control unit transmits a second signal to the power supply unit through a signal transmission circuit of a first communication unit to turn on the power supply unit; b) initializing the light source drive unit by transmitting a communication control signal included in a first signal to the de-serializer through a serializer of the first communication unit; c) controlling a light source unit through the light source drive unit receiving an image signal by transmitting the image signal included in the first signal to the de-serializer through the serializer of the first communication unit; d) inactivating the power supply unit and the light source drive unit by transmitting the communication control signal included in the first signal to the de-serializer through the serializer of the first communication unit; and e) cutting-off, by the power supply unit, power from the light source drive unit and the de-serializer by transmitting the second signal to the power supply unit through the signal transmission circuit of the first communication unit to turn off the power supply unit, wherein the communication control signal in b) is an initialization mode signal, and the communication control signal in d) is a standby mode signal.

### BRIEF DESCRIPTION OF THE DRAWINGS

FIG. 1 is a block diagram schematically showing an internal configuration of a lamp system according to an embodiment of the present disclosure.

FIG. 2 is a view showing detailed configurations of a first communication unit and a second communication unit according to an embodiment of the present disclosure.

FIGS. 3A and 3B are views each showing a signal of a coaxial line connecting the first communication unit with the second communication unit according to an embodiment of the present disclosure.

FIG. 4 is a view schematically showing configurations of a serializer and a de-serializer according to an embodiment of the present disclosure.

FIG. 5 is a view showing a signal transmission circuit of the first communication unit and a signal reception circuit of the second communication unit in another example of the present disclosure.

FIGS. 6 and 7 are views showing connection configurations of R1 to R3 and C1 to C4 with a coaxial line according to an embodiment of the present disclosure.

FIG. 8 is a view showing a control process of the lamp system according to another embodiment of the present disclosure.

### DETAILED DESCRIPTION

Hereinafter, embodiments of the present disclosure are described in detail with reference to the accompanying drawings so that those skilled in the art to which the present disclosure pertains may easily practice the present disclosure. The present disclosure may be implemented in various different forms and is not limited to the embodiments provided herein. A portion unrelated to the description is omitted in order to obviously describe the present disclosure, and the same or similar components are denoted by the same reference numerals throughout the specification. In addition, a detailed description of the widely and well known art is omitted.

Throughout the specification, unless explicitly described to the contrary, “including” any component should be understood to imply the inclusion of another element rather than the exclusion of another element.

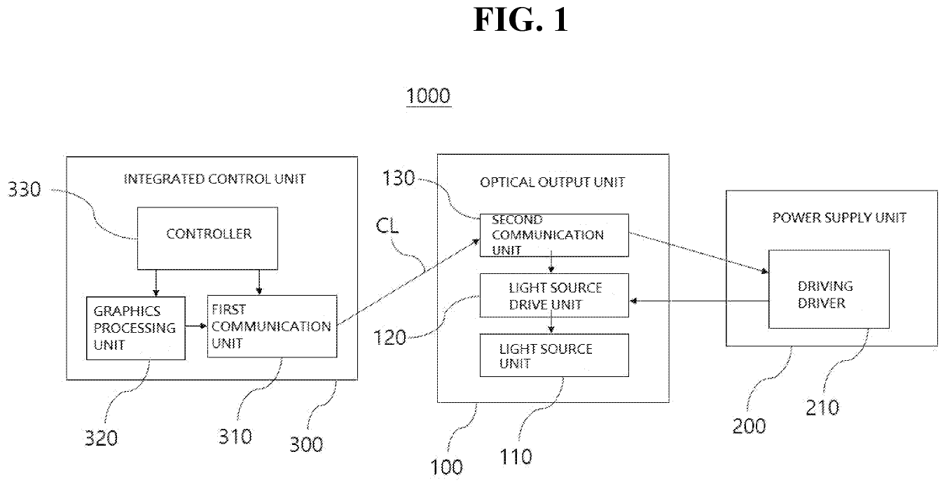

FIG. 1 is a block diagram schematically showing an internal configuration of a lamp system according to an embodiment of the present disclosure.

Referring to the drawing, a lamp system 1000 according to an embodiment of the present disclosure includes: an optical output unit 100 widely outputting light emitting diode (LED) light; a power supply unit 200 supplying power to the optical output unit 100; and an integrated control unit 300 connected to the optical output unit 100 to transmit a first signal including an image signal to be output from the optical output unit 100 and a second signal including a direct current (DC) control signal for controlling the power supply unit 200 together. the power supply unit 200 includes driving driver 210.

Here, the optical output unit 100 may output the image signal received from the integrated control unit 300. The optical output unit 100 may include a light source unit 110 outputting light, a light source drive unit 120 driving the light source unit 110 based on the received first signal, and a second communication unit 130 communicating with the integrated control unit 300 to transmit the received first signal to the light source drive unit 120 and transmit the second signal to the power supply unit 200.

Here, the light source unit 110 may output the received image signal. This light source unit 110 may include high-resolution modules such as an LED module or digital micromirror device (DMD) and high definition (HD) Micro LED modules, and may function not only as a lamp simply outputting light, but also as a lamp which may perform a communication function by outputting the image signal.

Meanwhile, the light source drive unit 120 may output light by individually controlling the plurality of light source units 110 based on the received image signal. The light source drive unit 120 may be controlled to be operated through power supply from the power supply unit 200.

In addition, the second communication unit 130 may be connected to a first communication unit 310 of the integrated control unit 300, which is described below, through a coaxial line CL to receive the first signal including the image signal and the second signal including the DC control signal for controlling the power supply unit from the integrated control unit 300.

In addition, the power supply unit 200 may supply power for driving the light source unit 110 of the optical output unit 100. The power supply unit 200 may supply power to or cut off power from the optical output unit 100 based on the DC control signal included in the second signal of the integrated control unit 300.

Meanwhile, the integrated control unit 300 may control the optical output unit 100 and the power supply unit 200 as described above. However, unlike a conventional control system performing the control through a communication line provided in each of the optical output unit 100 and the power supply unit 200, the integrated control unit 300 of the present disclosure may transmit the control signals of the optical output unit 100 and the power supply unit 200 through one communication line.

The integrated control unit 300 may include the first communication unit 310 connected to the optical output unit to enable its communication with the optical output unit, a graphics processing unit 320 generating the first signal to be transmitted to the optical output unit 100 and transmitting the generated first signal to the first communication unit 310, and a controller 330 controlling the graphics processing unit 320 and the power supply unit 200, and controlling the power supply unit 200 by transmitting the second signal for controlling the power supply unit 200 to the first communication unit 310.

As described above, one of the largest features of the present disclosure may be transmitting both the first signal and the second signal through one communication line connecting the integrated control unit 300 with the optical output unit 100 unlike the integrated control unit 300 connected to the optical output unit 100 and the power supply unit 200 conventionally through the separate communication lines, and respectively transmitting the first signal and the second signal through these separate communication lines.

Hereinafter, the description describes in more detail such a configuration of the present disclosure, in which the first signal and second signal are transmitted through one communication line.

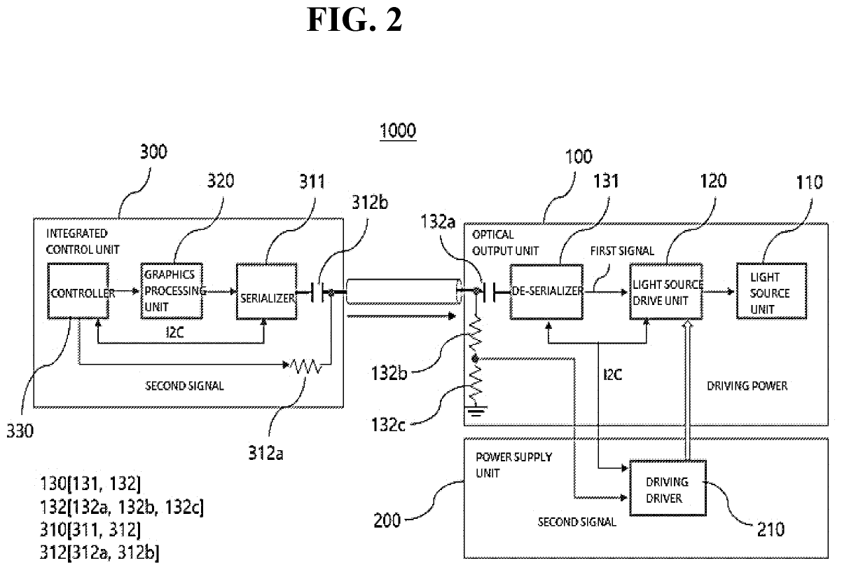

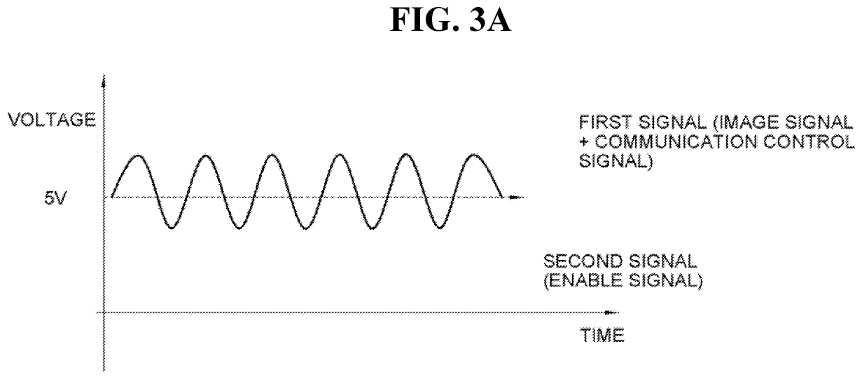

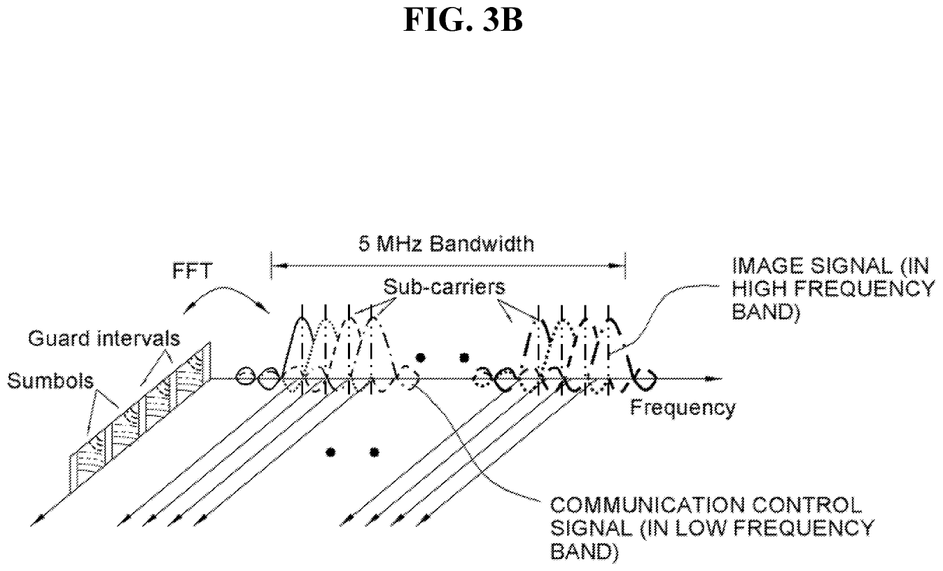

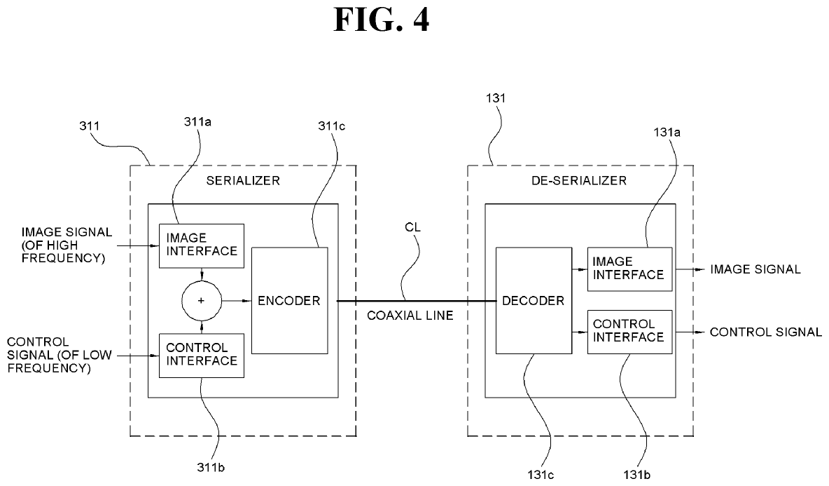

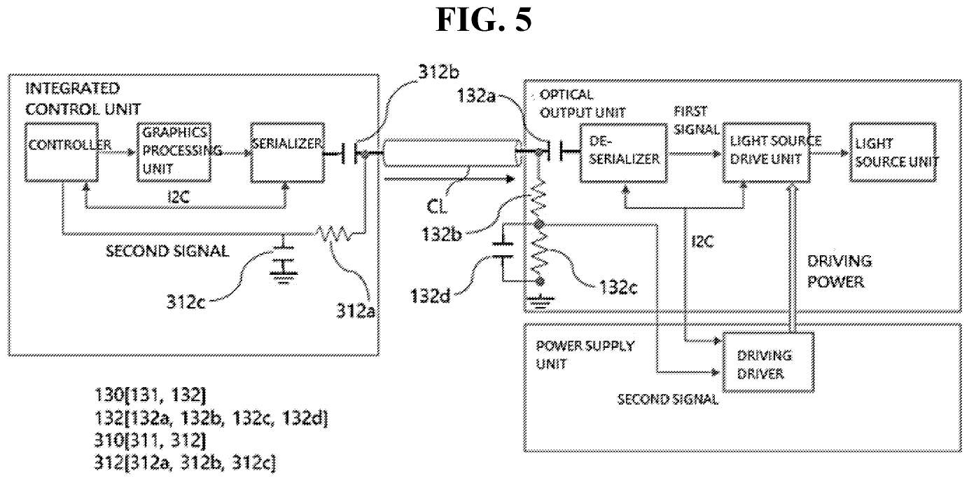

FIG. 2 is a view showing detailed configurations of a first communication unit and a second communication unit according to an embodiment of the present disclosure; FIGS. 3A and 3B are views each showing a signal of the coaxial line connecting the first communication unit with the second communication unit according to an embodiment of the present disclosure; FIG. 4 is a view schematically showing configurations of the serializer and the de-serializer according to an embodiment of the present disclosure; and FIG. 5 is a view showing a signal transmission circuit of the first communication unit and a signal reception circuit of the second communication unit in another example of the present disclosure.

Referring to the drawings, the first communication unit 310 and the second communication unit 130 may be connected to each other through the coaxial line CL according to an embodiment of the present disclosure.

The coaxial line CL may have a predetermined impedance to increase transmission efficiency of the first signal, and in one example, the predetermined impedance may be 50Ω.

In addition, the first communication unit 310 may include a serializer 311 converting the first signal transmitted from the graphics processing unit 320 into serial data and transmitting the serial data, and a signal transmission circuit 312 transmitting the second signal generated by the controller 330 to the second communication unit 130; and the second communication unit 130 may include a de-serializer 131 de-serializing the serial data received from the first communication unit 310 to the first signal, and a signal reception circuit 132 receiving the second signal of the first communication unit 310 and transmitting the received second signal to the power supply unit 200.

Here, the signal transmission circuit 312 may include a first resistor (R1) 312a having one end (or a first terminal) connected to the controller 330 and the other end (or a second terminal) connected to one end of the coaxial line CL, and a first capacitor (C1) 312b having one end connected to the serializer 311 and the other end connected to one end of the coaxial line CL. Accordingly, a DC component, which is a noise, may be removed through C1 312b from the first signal, which is an alternating current (AC) signal transmitted from the graphics processing unit 320 to the coaxial line CL via the serializer 311, and only the first signal, which is an AC component, may pass therethrough.

In addition, the first signal may be transmitted to the coaxial line CL, and simultaneously, the second signal including the DC control signal may be transmitted through the connection line connecting the controller 330, R1 312a, and the coaxial line CL with one another. Accordingly, as shown in FIG. 3, the first signal in the form of the AC signal and the second signal in the form of a DC signal may be merged with each other, and then transmitted to the optical output unit 100.

In addition, the first signal may include the image signal in a high frequency band and the communication control signal in a low frequency band, and the first signal may be serialized by the serializer 311.

That is, as shown FIG. 4, the image signal in the high frequency band that is transmitted from the graphics processing unit 320 may be transmitted to an image interface 311a of the serializer 311, the communication control signal in the low frequency band may be transmitted to a control interface 311b, and these two signals may then be serialized to one synthesized signal through an encoder 311c.

Meanwhile, the signal reception circuit 132 may include a second capacitor (C2) 132a having one end connected to the other end of the coaxial line CL and the other end connected to the de-serializer 131, and a second resistor (R2) 132b having one end connected to the other end of the coaxial line CL, and a third resistor (R3) 132c having one end connected to the other end of R2 132b and the other end grounded.

Here, R2 132b may have the other end connected to the power supply unit 200 to transmit the second signal to the power supply unit 200.

In addition, as shown in FIG. 5, the signal transmission circuit 312 and the signal reception circuit 132 may respectively have a third capacitor (C3) 312c and a fourth capacitor (C4) 132d connected thereto to remove, from the circuits, the AC component which is a noise component that may be included in the second signal. Here, C3 312c may have one end connected to the controller 330 and the other end grounded, and C4 132d may have one end connected to the other end of R2 132b and the other end grounded to be connected in parallel with R3 132c.

Here, C1 312b may be sufficiently larger than C3 312c, C2 132a may be sufficiently larger than C4 132d, and C4 132d may be sufficiently larger than C3 312c.

In an example of the present disclosure, C1 312b and C2 132a may use 220 nF, C3 312c may use 1 nF, and C4 132d may use 10 nF.

In addition, R1 312a and R2 132b may each have 42KΩ, and R3 132c may have 220KΩ.

Meanwhile, although not shown in FIG. 5, a resistor may be further provided to have one end connected to one end of the coaxial line CL or the other end of R1 312a and the other end connected to an analog to digital converter (ADC) port, and have the same impedance as R1 to detect whether its connection with the coaxial line CL is disconnected.

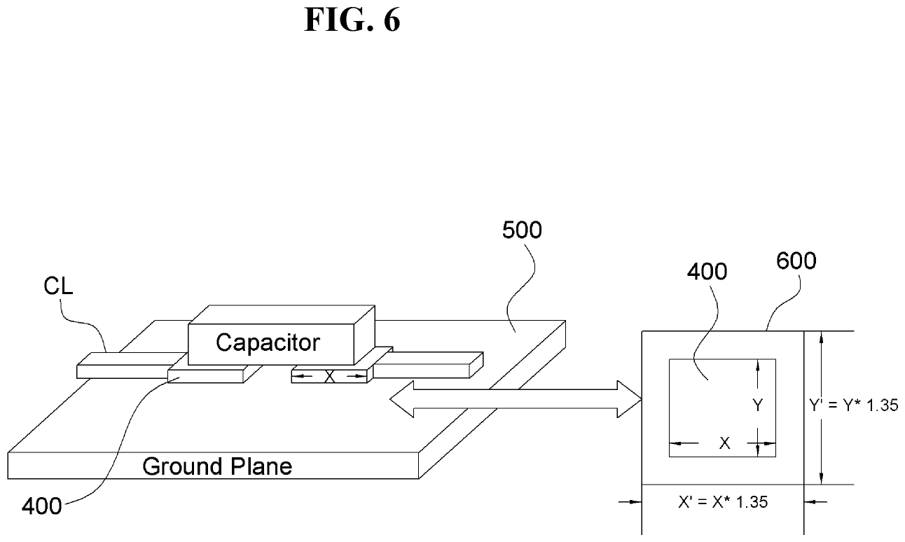

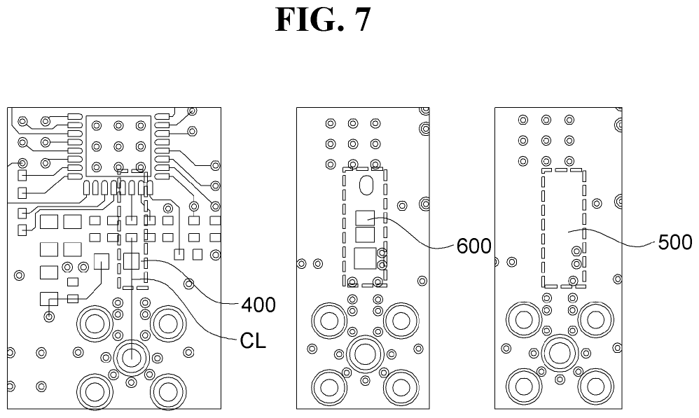

FIGS. 6 and 7 are views showing connection configurations of R1 to R3 and C1 to C4 with the coaxial line according to an embodiment of the present disclosure.

Referring to the drawings, according to the present disclosure, both the ends of R1 to R3 and C1 to C4 may be connected to the coaxial line CL through a component pad 400, and the component pad 400 and the coaxial line CL may be stacked on a ground plate 500.

Here, the coaxial line CL may be the coaxial line CL connecting the first communication unit 310 with the second communication unit 130, or a connection line connecting R1 to R3 and C1 to C4 with each other or R1 to R3 and C1 to C4 with the controller 330 or the power supply unit 200.

In addition, as shown in FIG. 7, an auxiliary layer 600 may be further provided between the component pad 400 or the coaxial line CL and the ground plate 500, and the auxiliary layer 600 disposed below the component pad 400 may be cut off when the horizontal or vertical length of the component pad 400 is greater than a width of the coaxial line CL based on a horizontal cross section of the component pad 400 bonded to the R1 to R3 and the C1 to C4, and its cut-off region may have a size of 1.3 to 1.4 times the horizontal or vertical length of the component pad 400.

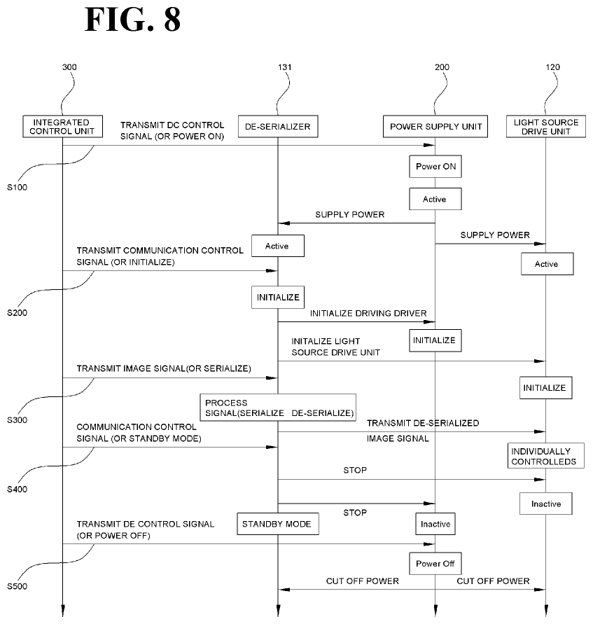

FIG. 8 is a view showing a control process of the lamp system according to another embodiment of the present disclosure.

Referring to the drawing, a control method of a lamp system 1000 according to another embodiment of the present disclosure includes: activating, by a power supply unit 200, a light source drive unit 120 and a de-serializer 131 by supplying power thereto as an integrated control unit 300 transmits a second signal to the power supply unit 200 through a signal transmission circuit 312 of a first communication unit 310 to turn on the power supply unit 200 (S100); initializing the light source drive unit 120 by transmitting a communication control signal included in a first signal to the de-serializer 131 through a serializer 311 of the first communication unit 310 (S200); controlling a light source unit 110 through the light source drive unit 120 receiving an image signal by transmitting the image signal included in the first signal to the de-serializer 131 through the serializer 311 of the first communication unit 310 (S300); inactivating the power supply unit 200 and the light source drive unit 120 by transmitting the communication control signal included in the first signal to the de-serializer 131 through the serializer 311 of the first communication unit 310 (S400); and cutting-off, by the power supply unit 200, power from the light source drive unit 120 and the de-serializer 131 by transmitting the second signal to the power supply unit 200 through the signal transmission circuit 312 of the first communication unit to turn off the power supply unit 200 (S500).

That is, according to the control method of the present disclosure, the integrated control unit 300 may normally turn off the power supply unit 200 to minimize power consumption, and turn on the power supply unit 200 if necessary based on an instruction of the integrated control unit 300.

The instruction of the integrated control unit 300 may be transmitted through the DC control signal, which is the second signal.

In addition, the communication control signal in S200 may be an initialization mode signal, and the communication control signal in S400 may be a standby mode signal.

As set forth above, the lamp system according to the present disclosure may have the reduced material cost and the improved assembly through the communication line integration by transmitting the image signal and the DC control signal together through the communication line between the integrated control unit and the optical output unit.

Although the embodiments are described in the present disclosure as above, the present disclosure is not limited to the specific embodiments described above. That is, it is apparent to those skilled in the art to which the present disclosure pertains that various variations and modifications could be made without departing from the spirit and scope of the appended claims, and all such appropriate variations and modifications should be considered as falling within the scope of the present disclosure as equivalents.

What is claimed is:

1. A lamp system comprising:
an optical output unit configured to output light;
a power supply unit configured to supply power to the optical output unit; and
a control unit connected to the optical output unit and configured to generate (1) a first signal including an image signal transmitted to be output from the optical output unit; and (2) a second signal including a direct current (DC) control signal transmitted to control the power supply unit,
wherein the control unit includes:
a first communication unit in communication with the optical output unit;
a graphics processing unit configured to generate and transmit the first signal to the first communication unit; and
a controller configured to (1) control the graphics processing unit and the power supply unit and (2) transmit the second signal to the first communication unit for controlling the power supply unit.

2. The system of claim 1, wherein the optical output unit includes:
a light source unit configured to output the light;
a light source drive unit configured to receive the first signal and drive the light source unit based on the received first signal; and
a second communication unit in communication with the first communication unit and configured to transmit the first signal to the light source drive unit and transmit the second signal to the power supply unit.

3. The system of claim 2, further comprising a coaxial line connected between the first communication unit and the second communication unit.

4. The system of claim 3, wherein:
the first communication unit includes (1) a serializer configured to convert the first signal transmitted from the graphics processing unit into serial data and transmit the serial data, and (2) a signal transmission circuit configured to transmit the second signal generated by the controller to the second communication unit, and
the second communication unit includes (1) a de-serializer configured to de-serialize the serial data received from the first communication unit to the first signal, and (2) a signal reception circuit configured to receive the second signal from the first communication unit and transmit the received second signal to the power supply unit.

5. The system of claim 4, wherein:
the serializer includes an encoder configured to convert the first signal transmitted from the graphics processing unit into the serial data,
the de-serializer includes a decoder configured to de-serialize the serial data transmitted from the serializer through the coaxial line, and
the first signal includes the image signal in a high frequency band and a communication control signal in a low frequency band.

6. The system of claim 4, wherein:
the signal transmission circuit includes (1) a first resistor (R1) having a first terminal connected to the controller and a second terminal connected to a first end of the coaxial line, and (2) a first capacitor (C1) having a first terminal connected to the serializer and a second terminal connected to the first end of the coaxial line,
the signal reception circuit includes (1) a second capacitor (C2) having a first terminal connected to the second end of the coaxial line and a second terminal connected to the de-serializer, (2) a second resistor (R2) having a first terminal connected to the second end of the coaxial line, and (3) a third resistor (R3) having a first terminal connected to the second terminal of the second resistor (R2) and a second terminal grounded, and
the second resistor (R2) has a second terminal connected to the power supply unit to transmit the second signal to the power supply unit.

7. The system of claim 6, wherein:
the signal transmission circuit further includes a third capacitor (C3) having a first terminal connected to the controller and a second terminal grounded to remove an alternating current (AC) noise from the second signal,
the signal reception circuit further includes a fourth capacitor (C4) having a first terminal connected to the second terminal of the second resistor (R2) and a second terminal grounded to be connected in parallel with the third resistor (R3) and remove the AC noise from the received second signal, and
a capacitance of the first capacitor (C1) is greater than that of the third capacitor (C3), a capacitance of the second capacitor (C2) is greater than that of the fourth capacitor (C4), and a capacitance of the third capacitor (C3) is less than that of the fourth capacitor (C4).

8. The system of claim 7, wherein an impedance of the coaxial line is 50 Ω.

9. The system of claim 8, further comprising:
a component pad stacked with the coaxial line on a ground plate; and
an auxiliary layer disposed between (1) the component pad or the coaxial line and (2) the ground plate,
wherein the first and second terminals of the first, second and third resistors (R1, R2 and R3) and the first, second, third and fourth capacitance (C1, C2, C3 and C4) are connected to the coaxial line through the component pad,
wherein a portion of the auxiliary layer below the component pad is cut off when a horizontal or vertical length of the component pad is greater than a width of the coaxial line, and
wherein the portion cut off from the auxiliary layer is 1.3 to 1.4 times longer than the horizontal or vertical length of the component pad.

10. A method for operating the lamp system of claim 5, comprising:
a) activating, by the power supply unit, the light source drive unit and the de-serializer by supplying the power to the light source drive unit and the de-serializer while the control unit transmits the second signal to the power supply unit through the signal transmission circuit of the first communication unit to turn on the power supply unit;
b) initializing the light source drive unit by transmitting the communication control signal included in the first signal to the de-serializer through the serializer of the first communication unit;
c) controlling the light source unit through the light source drive unit receiving the image signal by transmitting the image signal included in the first signal to the de-serializer through the serializer of the first communication unit;
d) inactivating the power supply unit and the light source drive unit by transmitting the communication control signal included in the first signal to the de-serializer through the serializer of the first communication unit; and
e) cutting-off, by the power supply unit, the power from the light source drive unit and the de-serializer by transmitting the second signal to the power supply unit through the signal transmission circuit of the first communication unit to turn off the power supply unit,
wherein the communication control signal in b) comprises an initialization mode signal, and the communication control signal in d) comprises a standby mode signal.
